(19) United States
(12) Patent Application Publication
(10) Pub. No.: US 2022/0271313 A1
(43) Pub. Date: Aug. 25, 2022

(54) UNIT CELL, AND METHOD OF PRODUCING STACK BODY INCLUDING THE UNIT CELL

(71) Applicant: HONDA MOTOR CO., LTD., Tokyo (JP)

(72) Inventor: Taichi KITAGAWA, WAKO-SHI (JP)

(21) Appl. No.: 17/591,776

(22) Filed: Feb. 3, 2022

(30) Foreign Application Priority Data
Feb. 22, 2021 (JP) 2021-026338

(51) Int. Cl. H01M 8/1004; H01M 8/0247; H01M 8/0286; H01M 8/0276

(52) U.S. Cl. CPC H01M 8/1004; H01M 8/0247; H01M 8/0286; H01M 8/0276

(57) ABSTRACT

A unit cell includes a membrane electrode assembly, a resin frame member, a first separator, and a second separator. The membrane electrode assembly includes an electrolyte membrane, a first electrode, and a second electrode. A window section is formed in the resin frame member. An inner marginal portion of the window section enters between an outer marginal portion of the first electrode and an outer marginal portion of the electrolyte membrane. A ridge is provided on the second separator. The second separator is disposed adjacent to the second electrode. The ridge and the resin frame member are joined together through hot melt.

### CROSS-REFERENCE TO RELATED APPLICATIONS

This application is based upon and claims the benefit of priority from Japanese Patent Application No. 2021-026338 filed on Feb. 22, 2021, the contents of which are incorporated herein by reference.

### BACKGROUND OF THE INVENTION

### Field of the Invention

The present invention relates to a unit cell for a fuel cell formed by sandwiching a resin framed membrane equipped assembly between a first separator and a second separator, and a method of producing a stack body including the unit cell.

### Description of the Related Art

A unit of a fuel cell (unit cell) is formed by sandwiching a membrane electrode assembly (MEA) between a pair of separators. The membrane electrode assembly includes an anode disposed on one end surface of an electrolyte membrane, and a cathode disposed on the other end surface of the electrolyte membrane. In general, the fuel cell is in the form of a fuel cell stack formed by stacking a predetermined number of the unit cells together. For example, the fuel cell stack is incorporated into a fuel cell vehicle (fuel cell electric automobile, etc.).

Since the electrolyte membrane is a thin membrane, in the case of structure where the electrolyte membrane is exposed from the outer peripheral portion of the MEA, the electrolyte membrane is deflected easily, and damaged easily. In this regard, in recent years, for ease of handling the MEA, it is proposed to incorporate the resin framed member in the outer peripheral portion of the MEA to form a resin framed membrane electrode assembly. In this case, since the MEA is held by the resin frame member having rigidity, operation of sandwiching the MEA between separators, etc. become easy. Further, since it becomes possible to reduce the area of the expensive electrolyte membrane to reduce the material of the electrolyte membrane, it is possible to achieve the cost reduction.

FIG. 2 of JP 2018-097917 A shows a resin frame member in the form of a film. The resin frame member is formed by a first frame member having a first window section of a small opening area, and a second frame member having a second window section of a large opening area in comparison with the first window section. In this case, the first frame member and the second frame member are joined together using adhesive. Thereafter, one surface of the first window section is covered with an anode, and the other surface of the first window section is covered with an electrolyte membrane and a cathode. In this manner, the resin framed membrane electrode assembly is obtained.

The adhesive provided on the other surface of the first frame member, and exposed from the second window section is adhered to the electrolyte membrane. That is, the outer marginal portion of the electrolyte membrane is joined to the inner marginal portion of the first frame member through adhesive joining the first frame member and the second frame member.

The separator, the first frame member, and the second frame member are joined together by laser welding. That is, the laser beam is radiated from the outside of the separator. As a result, the temperature of the separator is increased locally by this laser beam, and the first frame member and the second frame member which contact the separator are melt. Radiation of the laser beam is stopped to cool and solidify the laser beam incident area. As a result, the separator, the first frame member, and the second frame member are joined together.

### SUMMARY OF THE INVENTION

A main object of the present invention is to provide a unit cell for a fuel cell which makes it possible to simplify the steps of producing the unit cell.

Another object of the present invention is to provide a method of producing a stack body including the above described unit cell.

According to an embodiment of the present invention, a unit cell for a fuel cell is provided. The unit cell includes a resin framed membrane electrode assembly and a first separator and a second separator sandwiching the resin framed membrane electrode assembly. The resin framed membrane electrode assembly is formed by holding a membrane electrode assembly by a resin frame member. The membrane electrode assembly includes a first electrode, a second electrode, and an electrolyte membrane interposed between the first electrode and the second electrode.

The first separator is provided adjacent to the first electrode and the second separator is provided adjacent to the second electrode.

A window section is formed in the resin frame member, and an inner marginal portion of the window section is interposed between an outer marginal portion of the first electrode and an outer marginal portion of the electrolyte membrane in a manner that one end surface of the inner marginal portion faces the outer marginal portion of the first electrode, and another end surface of the inner marginal portion faces the outer marginal portion of the electrolyte membrane through hot melt.

A ridge provided on the second separator and protruding toward the resin frame member is joined to the other end surface through the hot melt provided on at least part of the other surface.

Further, according to another aspect of the present invention, a method of producing a stack body formed by stacking unit cells for a fuel cell is provided. Each of the unit cells includes a resin framed membrane electrode assembly and a first separator and a second separator sandwiching the resin framed membrane electrode assembly. The resin framed membrane electrode assembly is formed by holding a membrane electrode assembly by a resin frame member. The membrane electrode assembly includes a first electrode, a second electrode, and an electrolyte membrane interposed between the first electrode and the second electrode.

The method includes the steps of producing a resin framed membrane electrode assembly by forming a window section in the resin frame member and interposing an inner marginal portion of the window section between the outer marginal portion of the first electrode and the outer marginal portion of the electrolyte membrane in a manner that one end surface of the inner marginal portion faces the outer marginal portion of the first electrode and another end surface of the inner marginal portion faces the outer marginal portion of the electrolyte membrane and hot melt is joined to at least part of the other end surface, bringing a ridge provided on the second separator into contact with the hot melt, and applying heat to the hot melt, and joining the resin frame member and the electrolyte membrane together through the hot melt.

In the present invention, the resin frame member and the second separator are joined together through the hot melt. Therefore, at the time of joining the second separator to the resin frame member together, there is no need to perform laser welding, etc. which is performed in general. Therefore, the steps of producing the unit cell are simplified, and it becomes possible to carry out the production steps in a short period of time. Therefore, it is possible to produce a larger number of unit cells in the same period of time as the period of time which is required in the case of producing the unit cells by laser welding. In this manner, it is possible to achieve improvement in the production efficiency of producing the unit cells.

Further, since the expensive laser welding apparatus is not required, the facility of producing the unit cell is simplified. Moreover, it is possible to achieve reduction in the investment of the facility.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing main part of a unit cell according to an embodiment of the present invention;

FIG. 2 is a cross sectional view taken along a line II-II in FIG. 1;

FIG. 3 is a schematic flow showing a method of producing a stack body according to the embodiment of the present invention;

FIG. 4 is a schematic perspective view showing main part in a state where a resin framed membrane electrode assembly is produced;

FIG. 5 is a front view schematically showing main part of a state where a joint separator is held by a holder panel of a hot press system; and

FIG. 6 is a front view schematically showing main part of a state where the joint separator is joined to the resin framed membrane electrode assembly.

### DESCRIPTION OF THE INVENTION

Hereinafter, a preferred embodiment of a unit cell according to the present invention will be described in detail in relation to a method of producing a stack body including the unit cell with reference to the accompanying drawings.

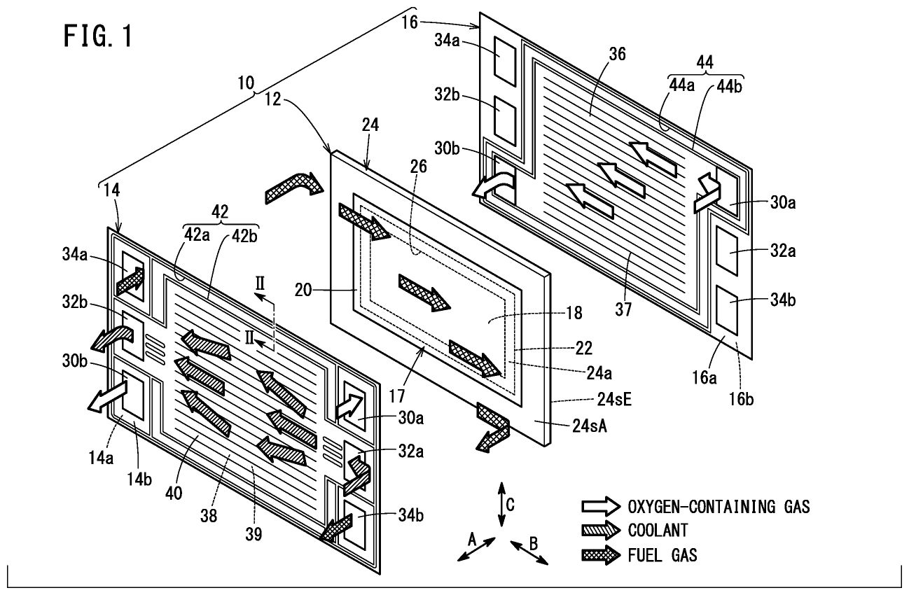

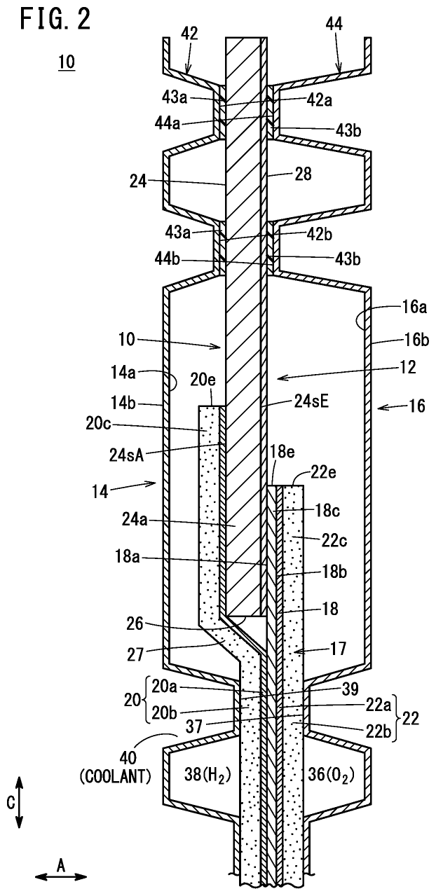

FIG. 1 is an exploded perspective view showing main part of a unit cell 10 according to the embodiment of the present invention. FIG. 2 is a cross sectional view taken along a line II-II in FIG. 1. The unit cell 10 is a solid polymer electrolyte fuel cell. Normally, a predetermined number of the unit cells are stacked together to form a fuel cell stack. However, only one unit cell 10 may form a fuel cell.

The unit cell 10 includes a resin framed membrane electrode assembly 12 (hereinafter also referred to as the “resin framed MEA”), and a first separator 14 and a second separator 16 disposed on both sides of the resin framed MEA 12. Stated otherwise, in the unit cell 10, the resin framed MEA 12 is sandwiched between the first separator 14 and the second separator 16. In this case, each of the resin framed MEA 12, the first separator 14, and the second separator 16 has a laterally elongated rectangular shape. Therefore, the unit cell 10 has a laterally elongated rectangular shape. It should be noted that the unit cell 10 may be elongated longitudinally, or may have a square shape.

For example, each of the first separator 14 and the second separator 16 is a steel plate, a stainless steel plate, an aluminum plate, a titanium plate, a plated steel plate, or a metal plate having an anti-corrosive surface by surface treatment.

The resin framed MEA 12 includes a membrane electrode assembly (hereinafter referred to as the “MEA”) 17 and a resin frame member 24 joined to, and provided around an outer peripheral portion of the MEA 17. The MEA 17 includes an electrolyte membrane 18, an anode (first electrode) 20 provided on one surface 18a of the electrolyte membrane 18, and a cathode (second electrode) 22 provided on the other surface 18b of the electrolyte membrane 18.

For example, the electrolyte membrane 18 is a solid polymer electrolyte membrane (cation ion exchange membrane). For example, the sold polymer electrolyte membrane is a thin membrane of perfluorosulfonic acid containing water. The electrolyte membrane 18 is held between the anode 20 and the cathode 22. A fluorine based electrolyte may be used as the electrolyte membrane 18. Alternatively, an HC (hydrocarbon) based electrolyte may be used as the electrolyte membrane 18.

In this case, the outer dimensions of the anode 20 are larger than the outer dimensions of the electrolyte membrane 18 and the cathode 22 (the height in the direction indicated by an arrow C and the depth in the direction indicated by an arrow B). The outer dimensions referred hereinafter also mean the height in the direction indicated by the arrow C and the depth in the direction indicated by the arrow B. Therefore, the outer marginal portion 20c of the anode 20 protrudes from the outer marginal end surfaces 18e, 22e of the electrolyte membrane 18 and the cathode 22.

The anode 20 has a first electrode catalyst layer 20a joined to one surface 18a of the electrolyte membrane 18, and a first gas diffusion layer 20b stacked on the first electrode catalyst layer 20a. The outer dimensions of the first electrode catalyst layer 20a and the first gas diffusion layer 20b are the same, and larger than the outer dimensions of the electrolyte membrane 18 and the cathode 22 as described above.

The cathode 22 includes a second electrode catalyst layer 22a joined to a surface 18b of the electrolyte membrane 18, and a second gas diffusion layer 22b stacked on the second electrode catalyst layer 22a. The outer dimensions of the second electrode catalyst layer 22a and the second gas diffusion layer 22b are the same, and are the same as the outer dimensions of the electrolyte membrane 18. Therefore, as shown in FIG. 2, the positions of the outer marginal portions 18c, 22c of the electrolyte membrane 18 and the cathode 22 are aligned (overlapped) with each other. Further, outer marginal end surface 22e of the cathode 22 and the outer marginal end surface 18e of the electrolyte membrane 18 are positioned inside the outer marginal end surface 20e of the anode 20.

The first electrode catalyst layer 20a is formed by depositing porous carbon particles uniformly on the surface of the first gas diffusion layer 20b together with ion conductive polymer binder, and platinum alloy is supported on surfaces of the carbon particles. The second electrode catalyst layer 22a is formed by depositing porous carbon particles uniformly on the surface of the second gas diffusion layer 22b together with ion conductive polymer binder, and platinum alloy is supported on surfaces of the carbon particles.

Each of the first gas diffusion layer 20b and the second gas diffusion layer 22b comprises a carbon paper, a carbon cloth, etc. The outer dimensions of the second gas diffusion layer 22b are smaller than the outer dimensions of the first gas diffusion layer 20b. The first electrode catalyst layer 20a and the second electrode catalyst layer 22a face each end surface of the electrolyte membrane 18.

The resin frame member 24 is made of a single plate material, and a window section 26 is formed to penetrate through substantially the central portion of the resin frame member 24 (in the stacking direction indicated by the arrow A). Therefore, the resin frame member 24 has a rectangular outer shape. Suitable examples of resin materials of the resin frame member 24 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

The inner marginal portion 24a as a marginal portion of the window section 26 in the resin frame member 24 is sandwiched between the outer marginal portion 20c of the anode 20 and the outer marginal portion 18c of the electrolyte membrane 18. Stated otherwise, the inner marginal portion 24a is interposed between the outer marginal portion 20c of the anode 20 and the outer marginal portion 18c of the electrolyte membrane 18. Therefore, one end surface of the resin frame member 24 faces the outer marginal portion 20c of the anode 20, and the other end surface of the resin frame member 24 faces the outer marginal portion 18c of the electrolyte membrane 18. Hereinafter, the one end surface will be referred to as the electrode side surface, the other end surface will be referred to as the electrolyte side end surface. The one end surface and the other end surface will be labeled with 24sA, 24sE, respectively.

The outer marginal portion 20c of the anode 20 is spaced from the outer marginal portion 18c of the electrolyte membrane 18, and rides on the inner marginal portion 24a of the electrode side end surface 24sA of the resin frame member 24. Therefore, an inclined area 27 is formed in the anode 20, adjacent to a portion overlapped with the inner marginal portion 24a of the electrode side end surface 24sA. The inclined area 27 is inclined away from the electrolyte membrane 18 toward the first separator 14. It is a matter of course that, in the inclined area 27, the first electrode catalyst layer 20a and the first gas diffusion layer 20b are inclined away from the electrolyte membrane 18.

The electrolyte membrane 18 and the cathode 22 are formed to have a substantially flat shape entirely. That is, the area of the cathode 22 overlapped with the inner marginal portion 24a (the second electrode catalyst layer 22a and the second gas diffusion layer 22b) and the electrolyte membrane 18 are substantially in parallel with the electrolyte side end surface 24sE. It should be noted that the outer marginal portion 20c of the anode 20 and the outer marginal portion 22c of the cathode 22 may be inclined away from the electrolyte membrane 18.

The inner marginal portion 24a of the resin frame member 24 and the outer marginal portion 18c of the electrolyte membrane 18 are joined together through hot melt 28 provided for the electrolyte side end surface 24sE (described later). On the other hand, no adhesive layer such as the hot melt 28 is provided specially between the electrode side end surface 24sA and the anode 20 (first electrode catalyst layer 20a). That is, the first electrode catalyst layer 20a only contacts the electrode side end surface 24sA, and is not joined to the electrode side end surface 24sA.

As shown in FIG. 1, at one end of the unit cell 10 in the direction indicated by the arrow B (horizontal direction), an oxygen-containing gas supply passage 30a, a coolant supply passage 32a, and a fuel gas discharge passage 34b are provided. The oxygen-containing gas supply passage 30a, the coolant supply passage 32a, and the fuel gas discharge passage 34b extend through the unit cell 10 in the stacking direction indicated by the arrow A. An oxygen-containing gas is supplied to the oxygen-containing gas supply passage 30a, and a coolant is supplied to the coolant supply passage 32a. A fuel gas such as a hydrogen-containing gas is discharged from the fuel gas discharge passage 34b. The oxygen-containing gas supply passage 30a, the coolant supply passage 32a, and the fuel gas discharge passage 34b are arranged in the direction indicated by an arrow C (vertical direction).

At the other end of the unit cell 10 in the direction indicated by the arrow B, a fuel gas supply passage 34a for supplying the fuel gas, a coolant discharge passage 32b for discharging the coolant, an oxygen-containing gas discharge passage 30b for discharging the oxygen-containing gas are provided. The fuel gas supply passage 34a, the coolant discharge passage 32b, and the oxygen-containing gas discharge passage 30b extend though the unit cell 10 in the direction indicated by the arrow A. The fuel gas supply passage 34a, the coolant discharge passage 32b, and the oxygen-containing gas discharge passage 30b are arranged in the direction indicated by the arrow C.

The second separator 16 has an oxygen-containing gas flow field 36 on its surface 16a facing the resin framed MEA 12. The oxygen-containing gas flow field 36 is connected to the oxygen-containing gas supply passage 30a and the oxygen-containing gas discharge passage 30b. Specifically, the oxygen-containing gas flow field 36 is formed between the second separator 16 and the resin framed MEA 12. The oxygen-containing gas flow field 36 includes a plurality of straight flow grooves (or wavy flow grooves) extending in the direction indicated by the arrow B.

The first separator 14 has a fuel gas flow field 38 on its surface 14a facing the resin framed MEA 12. The fuel gas flow field 38 is connected to the fuel gas supply passage 34a and the fuel gas discharge passage 34b. Specifically, the fuel gas flow field 38 is formed between the first separator 14 and the resin framed MEA 12. The fuel gas flow field 38 includes a plurality of straight flow grooves (or wavy flow grooves) extending in the direction indicated by the arrow B.

When the unit cells 10 are stacked together, a coolant flow field 40 extending in the direction indicated by the arrow B is formed between a surface 14b of the first separator 14 of one unit cell 10 and a surface 16b of the second separator 16 of another unit cell 10 which is adjacent to the first separator 14. The coolant flow field 40 is connected to the coolant supply passage 32a and the coolant discharge passage 32b.

As shown in FIG. 2, a plurality of ridges 39 are formed on the surface 14a of the first separator 14 facing the resin framed MEA 12. The ridges 39 form the fuel gas flow field 38. The ridges 39 are extended toward the anode 20, and contact the anode 20. A plurality of ridges 37 are formed on a surface 16a of the second separator 16 facing the resin framed MEA 12. The ridges 37 form the oxygen-containing gas flow field 36. The ridges 37 are extended toward the cathode 22, and contact the cathode 22. An MEA 17 is held between the ridges 37, 39.

A first bead seal 42 (ridge) is integrally formed on the surface 14a of the first separator 14. The first bead seal 42 is formed around the outer peripheral portion of the first separator 14. The first bead seal 42 is extended toward the resin frame member 24, and contacts the resin frame member 24 through a rubber seal 43a formed at the top portion of the first bead seal 42. In this regard, the first bead seal 42 is deformed elastically to have a seal function. That is, the portion between the surface 14a of the first separator 14 and the resin frame member 24 is sealed in an air-tight and liquid-tight manner.

Further, the first bead seal 42 includes an outer bead 42a and an inner bead 42b provided inwardly of the outer bead 42a. The inner bead 42b is formed around the fuel gas flow field 38, the fuel gas supply passage 34a, and the fuel gas discharge passage 34b in a manner that the fuel gas flow field 38 is connected to the fuel gas supply passage 34a and the fuel gas discharge passage 34b. Each of the beads 42a, 42b has a tapered shape in cross section which is narrowed toward its front end (toward the resin frame member 24). Each of the beads 42a, 42b has a flat front end (or curved front end). The outer bead 42a may be dispensed with. In this case, the first bead seal 42 has so called single seal structure including only the inner bead 42b.

A second bead seal 44 (ridge) is formed integrally on the surface 16a of the second separator 16. The second bead seal 44 is formed around the outer peripheral portion of the second separator 16. The first bead seal 42 and the second bead seal 44 face each other through the resin frame member 24. That is, the resin frame member 24 is held between the first bead seal 42 and the second bead seal 44.

The second bead seal 44 is extended toward the resin frame member 24, and contacts the resin frame member 24 through a rubber seal 43b formed at the top portion of the second bead seal 44. In this regard, the second bead seal 44 is deformed elastically to have a seal function. That is, the portion between the surface 16a of the second separator 16 and the resin frame member 24 is sealed in an air-tight and liquid-tight manner.

Further, the second bead seal 44 includes an outer bead 44a and an inner bead 44b provided inwardly of the outer bead 44a. The inner bead 44b is formed around the oxygen-containing gas flow field 36, the oxygen-containing gas supply passage 30a, and the oxygen-containing gas discharge passage 30b in a manner that the oxygen-containing gas flow field 36 is connected to the oxygen-containing gas supply passage 30a and the oxygen-containing gas discharge passage 30b. Each of the beads 44a, 44b has a tapered shape which is narrowed toward its front end (toward the resin frame member 24). Each of the beads 44a, 44b has a flat front end (or curved front end). The outer bead 44a may be dispensed with. In this case, the second bead seal 44 has so called single seal structure including only the inner bead 44b.

In the above structure, the hot melt 28 is provided on the electrolyte side end surface 24sE of the resin frame member 24, at least in a portion facing the electrolyte membrane 18 (inner marginal portion 24a), and a portion facing the inner bead 44b and the outer bead 44a.

That is, the outer marginal portion 18c of the electrolyte membrane 18 is joined to the inner marginal portion 24a of the electrolyte side end surface 24sE of the resin frame member 24 through the hot melt 28. It should be noted that the inner bead 44b and the outer bead 44a provided on the second separator 16 are joined to the electrolyte side end surface 24sE through the hot melt 28 and the rubber seal 43b. Further, the inner bead 42b and the outer bead 42a provided on the first separator 14 are joined to the electrode side end surface 24sA through the rubber seal 43a.

The hot melt 28 is made of so called thermoplastic resin. The hot melt 28 is in the solid state at room temperature, and melts when it is heated (when heat is applied to the hot melt 28). Thereafter, when heat is removed from the hot melt 28, the temperature of the hot melt 28 is decreased, and the hot melt 28 is solidified. When the hot melt 28 is cooled and solidified, the outer marginal portion 18c of the electrolyte membrane 18 and the inner marginal portion 24a of the electrolyte side end surface 24sE of the resin frame member 24 are joined together.

The fuel cell stack (or fuel cell) including the unit cell 10 having the above structure will be operated as follows:

As shown in FIG. 1, an oxygen-containing gas is supplied to the oxygen-containing gas supply passage 30a, and a fuel gas such as the hydrogen-containing gas is supplied to the fuel gas supply passage 34a. Further, a coolant such as water, ethylene glycol, or oil is supplied to the coolant supply passage 32a.

The oxygen-containing gas is guided from the oxygen-containing gas supply passage 30a into the oxygen-containing gas flow field 36 of the second separator 16 and moves in the direction indicated by the arrow B, and then, the oxygen-containing gas is supplied to the cathode 22 of the MEA 17. In the meanwhile, the fuel gas is guided from the fuel gas supply passage 34a into the fuel gas flow field 38 of the first separator 14. The fuel gas flows along the fuel gas flow field 38 in the direction indicated by the arrow B, and the fuel gas is supplied to the anode 20 of the MEA 17.

Thus, in each of the MEAs 17, the oxygen-containing gas supplied to the cathode 22 and the fuel gas supplied to the anode 20 are consumed by electrochemical reactions in the second electrode catalyst layer 22a and the first electrode catalyst layer 20a to perform power generation.

Then, in FIG. 1, the remainder of the oxygen-containing gas which is supplied to the cathode 22 and consumed at the cathode 22 is discharged along the oxygen-containing gas discharge passage 30b in the direction indicated by the arrow A. Likewise, the remainder of the fuel gas supplied to the anode 20 and consumed at the anode 20 is discharged along the fuel gas discharge passage 34b in the direction indicated by the arrow A.

Further, the coolant supplied to the coolant supply passage 32a flows into the coolant flow field 40 formed between the first separator 14 and the second separator 16, and then, the coolant flows in the direction indicated by the arrow B. After the coolant cools the MEA 17, the coolant is discharged from the coolant discharge passage 32b.

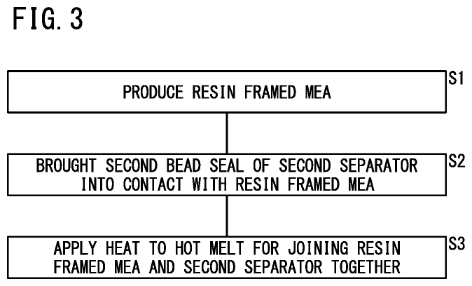

Next, a method of producing a stack body including the unit cells 10 having the above structure will be described with reference to a schematic flow shown in FIG. 3 additionally.

The method of producing the stack body according to the embodiment of the present invention includes a production step S1 of obtaining the resin framed MEA 12, and a contacting step S2 of bringing the second bead seal 44 of the second separator 16 into contact with the hot melt 28 provided on the electrolyte side end surface 24sE of the resin framed MEA 12, and a joining step S3 of applying heat to the hot melt 28. It should be noted that the process or operation in the production step S1 is performed automatically under operation of a robot (not shown).

In the production step S1, firstly, the anode 20 and the cathode 22 are obtained. In this regard, the first electrode catalyst layer 20a is provided on one end surface of the first gas diffusion layer 20b beforehand to form a roll body, and the anode 20 is obtained by cutting part of the roll body, for example. On the other hand, the second electrode catalyst layer 22a and the electrolyte membrane 18 are stacked in this order on one end surface of the second gas diffusion layer 22b to from a roll body, and the cathode 22 is obtained by cutting part of the roll body, for example. In this process, a stack body of the cathode 22 and the electrolyte membrane 18 is obtained.

In the meanwhile, the hot melt 28 in the form of a frame is provided, at positions facing the inner marginal portion 24a of the electrolyte side end surface 24sE of the resin frame member 24, the inner bead 44b, and the outer bead 44a. As described above, the hot melt 28 may be provided over the entire area of the electrolyte end surface 24sE.

Next, after the center of the window section 26 is aligned with the center of the electrolyte membrane 18, the resin frame member 24 is moved closer to the electrolyte membrane 18 relatively, to bring the outer marginal portion 18c of the electrolyte membrane 18 to the hot melt 28 provided at the inner marginal portion 24a. The dimensions of the window section 26 is smaller than the outer dimensions of the electrolyte membrane 18 and the cathode 22. Therefore, the inner marginal portion 24a and the outer marginal portion 18c have overlapping portions, and the opening of the window section 26 adjacent to the electrolyte side end surface 24sE is closed by the stack body (electrolyte membrane 18 and the cathode 22).

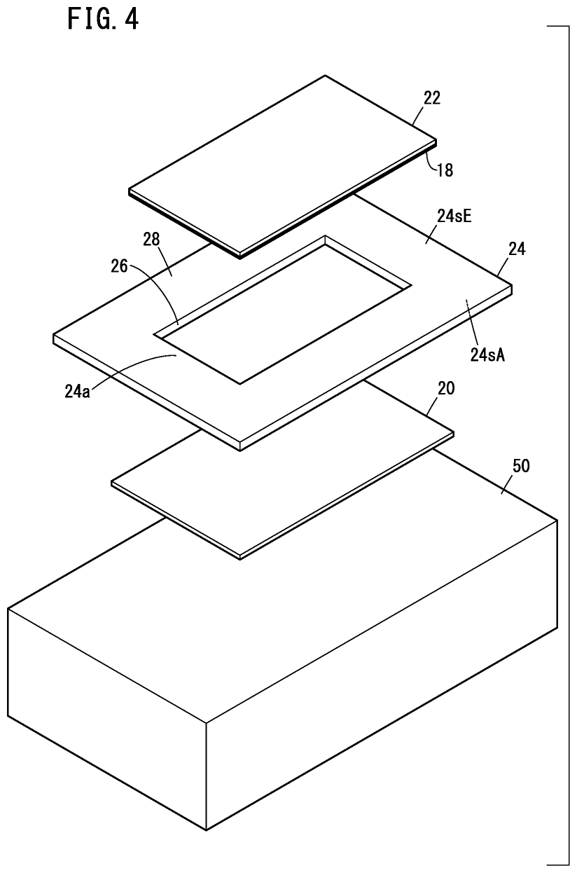

Additionally, as shown in FIG. 4, the anode 20 is fixedly positioned at a predetermined position of a placement plate 50. At this time, the first gas diffusion layer 20b faces the placement plate 50, and the first electrode catalyst layer 20a is oriented upright. The positioning and fixing are performed by vacuum suction, for example. For this purpose, it is adequate that the placement plate 50 having an air suction hole (not shown) can be used as the placement plate 50, and air suction can be performed through the air suction hole by a vacuum generator such as a vacuum pump (not shown).

Next, the resin frame member 24 provided with the cathode 22 on the electrolyte side end surface 24sE is oriented in a manner that the electrode side end surface 24sA is oriented downward and the electrolyte side end surface 24sE is oriented upward. Then, the resin frame member 24 is transported to a position above the anode 20. Further, the resin frame member 24 is moved downward toward the anode 20. Since the dimensions of the window section 26 are small in comparison with the anode 20, the outer marginal portion 20c of the anode 20 contacts the inner marginal portion 24a of the electrode side end surface 24sA. In this manner, a semi-finished product of the resin framed MEA 12 is obtained. In FIG. 4, for ease of understanding, the resin framed MEA 12 is shown in an exploded view.

Then, hot pressing is applied to the semi-finished product. That is, the pressure and the heat are applied to the semi-finished product at the same time. Therefore, the first electrode catalyst layer 20a of the anode 20 is joined to the electrolyte membrane 18, and at the same time, the outer marginal portion 18c of the electrolyte membrane 18 is joined to the inner marginal portion 24a of the electrolyte side end surface 24sE of the resin frame member 24 through the hot melt 28. At this time point, an inclined area 27 shown in FIG. 2 is formed.

Further, fluid passages 30a, 30b, 32a, 32b, 34a, 34b are formed at predetermined positions of the resin frame member 24 to obtain the resin framed MEA 12.

Additionally, the first separator 14 and the second separator 16 are produced by press forming of metal plates, for example. The fluid passages 30a, 30b, 32a, 32b, 34a, 34b, the oxygen-containing gas flow field 36, the fuel gas flow field 38, the coolant flow field 40, the first bead seal 42, the second bead seal 44, etc. are formed at this time point. Further, the rubber seal 43b such as silicone rubber is coated on the second bead seal 44 (the inner bead 44b and the outer bead 44a) of the obtained second separator 16. Further, likewise, the rubber seal 43a such as silicone rubber is coated on the first bead seal 42 (the inner bead 42b and the outer bead 42a) of the first separator 14.

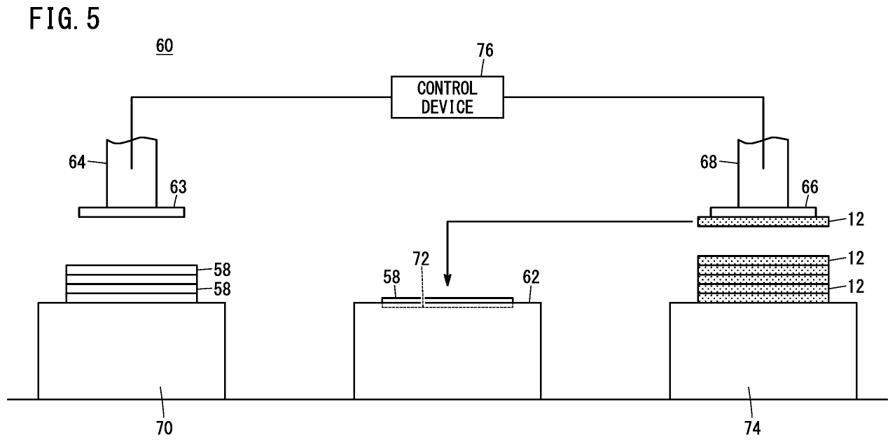

The resin framed MEA 12 is obtained in the manner described above, and the first separator 14 and the second separator 16 are joined together beforehand to form a joint separator 58 (see FIG. 5). Using the resin framed MEA 12 and the joint separator 58, the contacting step S2 as the next step is performed. In this regard, the surface 14b of the first separator 14 and the surface 16b of the second separator 16 along which the coolant flows are joined together, e.g., by laser welding.

In this case, a hot press system 60 is used, and main part of the hot press system 60 is shown in FIG. 5. The hot press system 60 will be described briefly. The hot press system 60 includes a holder panel 62, a first transportation robot 64 provided with a suction panel 63, and a second transportation robot 68 provided with a suction heating panel 66 (holder member).

The first transportation robot 64 includes a vacuum generator (not shown), and performs air suction through the suction panel 63 under operation of the vacuum generator. The first transportation robot 64 holds the joint separator 58 stored in a first stocker 70 by suction. It should be noted that an accommodating recess 72 is formed in the holder panel 62. The most part of the joint separator 58 is embedded in the accommodating recess 72. The first transportation robot 64 transports the joint separator 58 up to the holder panel 62, and introduces the joint separator 58 into the accommodating recess 72. The outer peripheral end of the joint separator 58 introduced into the accommodating recess 72 is positioned by the inner wall of the accommodating recess 72.

In the meanwhile, the suction heating panel 66 provided for the second transportation robot 68 holds the resin framed MEA 12 by suction. That is, the second transportation robot 68 is made up of the vacuum generator (not shown), and sucks the resin framed MEA 12 stored in a second stocker 74 by air suction through the suction heating panel 66 under operation of the vacuum generator. The second transportation robot 68 includes a heating mechanism (not shown). Under operation of the heating mechanism, the suction heating panel 66 is heated. Stated otherwise, the temperature is increased.

The second transportation robot 68 transports the resin framed MEA 12 to the holder panel 62, and the second transportation robot 68 is overlapped with the joint separator 58 put into the accommodating recess 72. In this regard, a camera (not shown) provided for the second transportation robot 68 is used to recognize the position of the accommodating recess 72 by image recognition to position the joint separator 58 and the resin framed MEA 12. Further, the second transportation robot 68 plays a role of collecting a joint body of the joint separator 58 and the resin framed MEA 12 by transporting the joint body to an unillustrated predetermined stocker, conveyor, etc. It is a matter of course that the first transportation robot 64 and the second transportation robot 68 are operated under the control operation of a control device 76.

The contacting step S2 is performed under operation of the hot press system 60 as follows: Specifically, a vacuum generator of the first transportation robot 64 of the hot press system 60 is actuated. As a result, the joint separator 58 of the first stocker 70 is held by the first transportation robot 64 through the suction panel 63. The first transportation robot 64 takes out the joint separator 58 from the first stocker 70, transports the joint separator 58 up to the holder panel 62, and as shown in FIG. 5, introduces the joint separator 58 into the accommodating recess 72. At this time, the joint separator 58 is oriented in a manner that the surface 16a of the second separator 16 is oriented upward.

Thereafter, the vacuum generator is stopped, and holding of the joint separator 58 by suction is released. Further, the first transportation robot 64 is retracted from the holder panel 62.

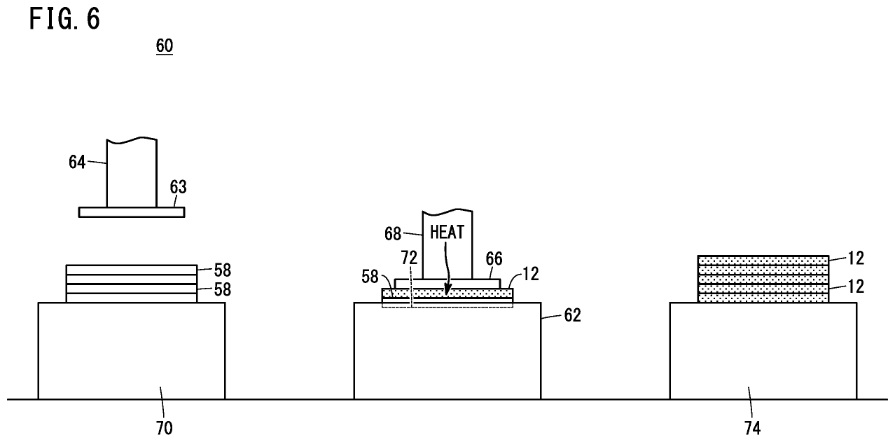

Next, the vacuum generator of the second transportation robot 68 is actuated. As a result, the resin framed MEA 12 is held by the suction heating panel 66 by suction, and taken out from the second stocker 74. The second transportation robot 68 transports the resin framed MEA 12 held by the suction heating panel 66 by suction, and as shown in FIG. 6, places the resin framed MEA 12 on the second separator 16 of the joint separator 58 put into the accommodating recess 72. It is a matter of course that, at this time point, the electrolyte side end surface 24sE of the resin framed MEA 12 faces the surface 16a of the second separator 16.

Therefore, the existing hot melt 28 provided for the electrolyte end surface 24sE is brought into contact with the top portion of the second bead seal 44 (the inner bead 44b and the outer bead 44a) of the second separator 16 through the rubber seal 43b. By this contact, the contacting step S2 is performed. At this time point, the vacuum generator may be stopped. However, air suction may be continued without any problems specially.

In this state, the joining step S3 is performed continuously. That is, the heating mechanism of the second transportation robot 68 is actuated, and the temperature of the suction heating panel 66 is increased accordingly. As a result, the heat is applied from the suction heating panel 66 to the resin framed MEA 12. Therefore, the hot melt 28 provided on the electrolyte side end surface 24sE of the resin frame member 24 is melt again. It should be noted that the suction heating panel 66 may apply a predetermined pressure force beyond the weight of the suction heating panel 66 to the joint separator 58 and the resin framed MEA 12 that are stacked together.

After the elapse of a predetermined period of time, the heating mechanism is stopped. As a result, the temperature of the suction heating panel 66 is decreased, and the hot melt 28 is cooled and solidified accordingly. Therefore, the outer marginal portion 18c of the electrolyte membrane 18 and the inner marginal portion 24a of the electrolyte side end surface 24sE of the resin frame member 24 are joined together again through the hot melt 28. At the same time, the top portion of the second bead seal 44 (the inner bead 44b and the outer bead 44a) of the second separator 16 and the electrolyte side end surface 24sE of the resin frame member 24 are joined together through the hot melt 28 and the rubber seal 43b. As a result, a joint body of the resin framed MEA 12 and the joint separator 58 is obtained.

After the elapse of sufficient time for cooling and solidifying the hot melt 28, under the suction operation of the suction heating panel 66, the second transportation robot 68 lifts the joint body, and removes the joint body from the accommodating recess 72. Further, the second transportation robot 68 collects the joint bodies by transporting the joint bodies to the stocker, the conveyor, etc.

The joint bodies obtained in this manner are stacked together successively. As a result, a stack body formed by stacking a predetermined number of unit cells 10 is obtained. The end plates disposed at both ends of the stack body are fastened together using tie rods, etc., and the portion between the resin framed MEA 12 and the first separator 14 is sealed by the first bead seal 42 (the inner bead 42b and the outer bead 42a) of the first separator 14 and the rubber seal 43a provided on the first bead seal 42.

As described above, in the embodiment of the present invention, by the hot melt 28 joining the resin frame member 24 and the electrolyte membrane 18 together, the resin frame member 24, and the second separator 16 in the joint separator 58 are joined together. Accordingly, the production step of producing the unit cells 10 is simplified. Therefore, it becomes possible to produce a large number of unit cells 10 in a short period of time. That is, it is possible to improve the production efficiency of producing the unit cells 10.

Further, since no laser welding apparatus is required, it is possible to simplify the facility of producing the unit cells 10. Moreover, it is possible to achieve reduction in the investment of the facility.

The present invention is not limited to the above embodiment. Various modifications can be made without departing from the gist of the present invention.

For example, in the embodiment of the present invention, the resin framed MEA 12 is overlapped on the joint separator 58, and the pressure and heat are applied from the resin framed MEA 12. Alternatively, the joint separator 58 may be overlapped on the resin framed MEA 12, and the pressure and heat may be applied from the joint separator 58.

Further, the outer dimensions of the anode 20 may be smaller than the outer dimensions of the electrolyte membrane 18 and the cathode 22. In this case, the outer marginal end surface 22e of the cathode 22 is disposed outside the outer marginal end surface 20e of the anode 20. Further, the anode 20 and the electrolyte membrane 18 are disposed in parallel to the electrolyte side end surface 24sE, and the inclined area 27 is formed in the cathode 22.

Alternatively, the outer dimensions of the anode 20, the electrolyte membrane 18, and the cathode 22 may be the same, and the positions of the outer marginal end surfaces 20e, 22e may be aligned with each other.

Further, at the time of performing press forming to obtain the first separator 14 and the second separator 16, it is not essential to form the first bead seal 42 and the second bead seal 44. Stated otherwise, the first separator 14 and the second separator 16 which do not include the first bead seal 42 and the second bead seal 44 may be produced. In this case, it is adequate that elastic rubber seals are provided on the surface 14a of the first separator 14 and the surface 16a of the second separator 16, respectively. In this manner, the present invention is applicable to the case of adopting the elastic rubber seals instead of the first bead seal 42 and the second bead seal 44. It should be noted that the rubber seals 43a, 43b may be dispensed with in the case where the first bead seal 42 and the second bead seal 44 are formed.

Moreover, at the time of heating the resin frame member 24 (resin framed MEA 12), the heat may be applied intensively or locally only to a portion where the hot melt 28 is provided. For example, a spot heater, etc. may be used to heat portions corresponding to the first bead seal 42 and the second bead seal 44 in a spot manner.

What is claimed is:

1. A unit cell for a fuel cell, the unit cell comprising:
a resin framed membrane electrode assembly formed by holding a membrane electrode assembly by a resin frame member, the membrane electrode assembly including a first electrode, a second electrode, and an electrolyte membrane interposed between the first electrode and the second electrode; a first separator and a second separator sandwiching the resin framed membrane electrode assembly,
wherein the first separator is provided adjacent to the first electrode and the second separator is provided adjacent to the second electrode;
a window section is formed in the resin frame member, and an inner marginal portion of the window section is interposed between an outer marginal portion of the first electrode and an outer marginal portion of the electrolyte membrane in a manner that one end surface of the inner marginal portion faces the outer marginal portion of the first electrode, and another end surface of the inner marginal portion faces the outer marginal portion of the electrolyte membrane through hot melt; and
a ridge provided on the second separator and protruding toward the resin frame member is joined to the another end surface through the hot melt provided on at least part of the another surface.

2. The unit cell according to claim 1, wherein the outer marginal portion of the electrolyte membrane is joined further to the another end surface through the hot melt provided on at least part of the another end surface.

3. The unit cell according to claim 1, wherein the ridge is a bead seal.

4. The unit cell according to claim 1, wherein a rubber seal is provided on a top portion of the ridge.

5. The unit cell according to claim 1, wherein outer dimensions of the first electrode are large in comparison with outer dimensions of the electrolyte membrane and the second electrode.

6. A method of producing a stack body formed by stacking unit cells for a fuel cell, the unit cells each comprising:
a resin framed membrane electrode assembly formed by holding a membrane electrode assembly by a resin frame member, the membrane electrode assembly including a first electrode, a second electrode, and an electrolyte membrane interposed between the first electrode and the second electrode; a first separator and a second separator sandwiching the resin framed membrane electrode assembly,
the method comprising the steps of:
producing a resin framed membrane electrode assembly by forming a window section in the resin frame member and interposing an inner marginal portion of the window section between an outer marginal portion of the first electrode and an outer marginal portion of the electrolyte membrane in a manner that one end surface of the inner marginal portion faces the outer marginal portion of the first electrode and another end surface of the inner marginal portion faces the outer marginal portion of the electrolyte membrane and hot melt is joined to at least part of the another end surface;
bringing a ridge provided on the second separator into contact with the hot melt, and
applying heat to the hot melt, and joining the resin frame member and the electrolyte membrane together through the hot melt.

7. The production method according to claim 6, wherein heat is applied to a portion of the hot melt which contacts the ridge in a spot manner.

8. The production method according to claim 6, wherein at the time of joining the resin frame member and the electrolyte membrane together, the resin frame member and the ridge are joined together through the hot melt provided on at least part of the another end surface.

9. The production method according to claim 6, wherein a rubber seal is provided on a top portion of the ridge.

10. The production method according to claim 6, wherein a holder member configured to hold either a joint separator formed by joining the first separator and the second separator together, or the resin framed membrane electrode assembly is heated to apply heat to the hot melt.

11. The production method according to claim 10, wherein as the holder member, a member configured to suck either the joint separator or the resin framed membrane electrode assembly by air suction from an air suction hole is used.
